(19) United States
(12) Patent Application Publication
(10) Pub. No.: US 2002/0153383 A1
(43) Pub. Date: Oct. 24, 2002

(54) Accommodating and positioning device of tissue paper case

(76) Inventor: Ming Jir Jang, Tai Chung City (TW)

Correspondence Address: JANG, MING JIR, P.O.BOX 63-150, Tai Chung City, 406, TW

(21) Appl. No.: 09/905,425

(22) Filed: Jul. 13, 2001

(30) Foreign Application Priority Data
Apr. 20, 2001 (TW) 90206434

(51) Int. Cl. G07F 11/00; A24F 15/04; B65H 1/00; A47K 10/24

(52) U.S. Cl. 221/24; 221/45

(57) ABSTRACT

The present invention discloses an accommodating and positioning device of a tissue paper case, comprising a main suspending body, and the exterior of the main suspending body is designed as a predetermined decoration so that the case body can be suspended in the car or indoors. The axial bottom of the main suspending body has an accommodation space for accommodating the tissue paper case, and the interior of the accommodation space has a suspending member to suspend the tissue paper in position such that the opening from where the tissue paper is drawn will always face downward. Such arrangement makes use of the gravity of the tissue paper to facilitate the operation of drawing the tissue paper from the tissue paper case, and it attains the purpose of not occupying too much space, definite drawing of paper, and giving an artistic appearance to the tissue paper case.

### BACKGROUND OF THE INVENTION

1. Field of the Invention

The present invention relates to an accommodating and positioning device of a tissue paper case, more particularly to an accommodating and positioning device of a suspending tissue paper case which prevents to occupy too much space, and facilitates the user to draw the tissue paper from the tissue paper case.

2. Description of the Related Art

The traditional case body for accommodating the tissue paper generally is the package of paper box (or plastic bag) as shown in FIG. 1. In the paper box 1, the pre-stacked tissue paper 2 placed in the paper box 1. When the tissue paper box is in use, the user draws the tissue paper upward by appropriate reverse action through the slit 3. When the user draws the tissue paper upward, it uses the weight w of the stacked tissue paper at the bottom to produce a reverse pulling action, which makes the drawing of tissue paper from the case body easy. After a period of time when certain quantity of tissue paper has been used, the weight of the entire tissue paper case become lighter and lighter. Then when the user draws the tissue paper from the case, it is found that the tissue paper with the case are pulled at the same time and unable to detach the tissue paper from the case. The user has to grab the tissue paper case by one hand, and pull the tissue paper by the other hand. Therefore, it generally has a plastic, wooden, or metal box to enclose the whole tissue paper case. It can make the tissue paper case look better, and the most important function is to add more weight to the tissue paper case in order to improve the above-mentioned shortcomings which will pull the tissue paper with the tissue paper case at the same time because of the light weight of the tissue paper case when the tissue paper is getting less and less. However, the tissue paper case has a specific area, and will occupy a certain area when it is place flat on the table. The tissue paper box for accommodating tissue paper definitely will occupy much larger space than the original tissue paper case. Particularly, in the restaurant, dining room, tabletop, kitchen, or desk where there are already many articles, therefore it does not allow us to have a tissue paper box that occupies lots of space.

In summation of the above description about the prior art that needs to have a breakthrough, the present inventor herein enhances the performance of the conventional structure by performing research and development to provide an easy and safe way of drawing and displaying the tissue paper.

### SUMMARY OF THE INVENTION

The main objective of the present invention is to provide an accommodating and positioning device of tissue paper case, by means of its space design to effective prevent the tissue paper from being pulled together with the tissue paper case when the tissue paper is getting less and less, and attains the definite effect of drawing the tissue paper from the tissue paper box.

The secondary objective of the present invention is to provide an accommodating and positioning device of tissue paper case, by means of the special shape of its structure, it resolves the problem of occupying too much space on the tabletop, and attains the purposes of not occupying too much space and possessing an artistic look.

AS the accommodating and positioning device of tissue paper case of the present invention, comprises a suspending main body, and the exterior of the suspending main body is designed with a predetermined decorative model for hanging in the car and any place indoors. The axial bottom of the suspending main body has an accommodating space for the tissue paper case. In the interior of the accommodating space, there is a suspending member for positioning the tissue paper case for the suspending, and making the slit for drawing the tissue paper to face downward. By such arrangement, the tissue paper can be drawn very easily due to the gravitation force of the tissue paper, and it further attains the objective of not occupying too much space, definite drawing of the tissue paper, and artistic appearance.

To make it easier for our examiner to understand the objective of the invention, its structure, innovative features, and its performance, we use a preferred embodiment together with the attached drawings for the detailed description of the invention.

### BRIEF DESCRIPTION OF THE DRAWINGS

Other objects, features, and advantages of the invention will become apparent from the following detailed description of the preferred but non-limiting embodiment. The description is made with reference to the accompanying drawings, in which:

FIG. 1 shows the situation of drawing the tissue paper from a traditional tissue paper case.

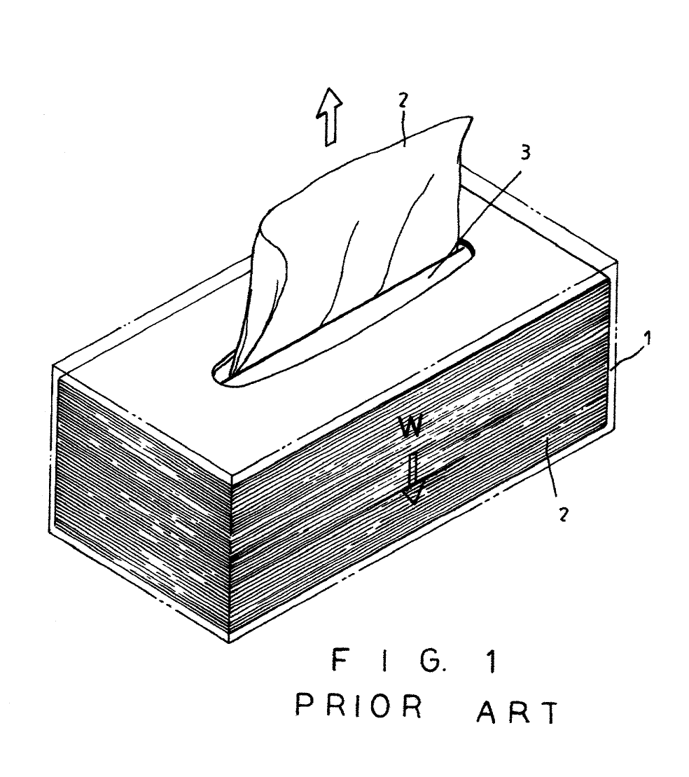

FIG. 2 shows the front view of the three-dimensional assembly of the tissue paper case according to a preferred embodiment of the present invention.

FIG. 3 shows the cross-sectional front view of FIG. 2.

FIG. 4 shows the back view of the three-dimensional assembly of the tissue paper case according to a preferred embodiment of the present invention.

FIG. 5 shows the three-dimensional assembly of the preferred embodiment of the suspending member of another type according to the present invention.

FIG. 6 shows the three-dimensional disassembled parts of the preferred embodiment of the suspending member of another type according to the present invention.

FIG. 7 shows the cross-sectional view of the assembly of the suspending member as illustrated in FIG. 6 of the present invention.

### DETAILED DESCRIPTION OF THE PREFERRED EMBODIMENTS

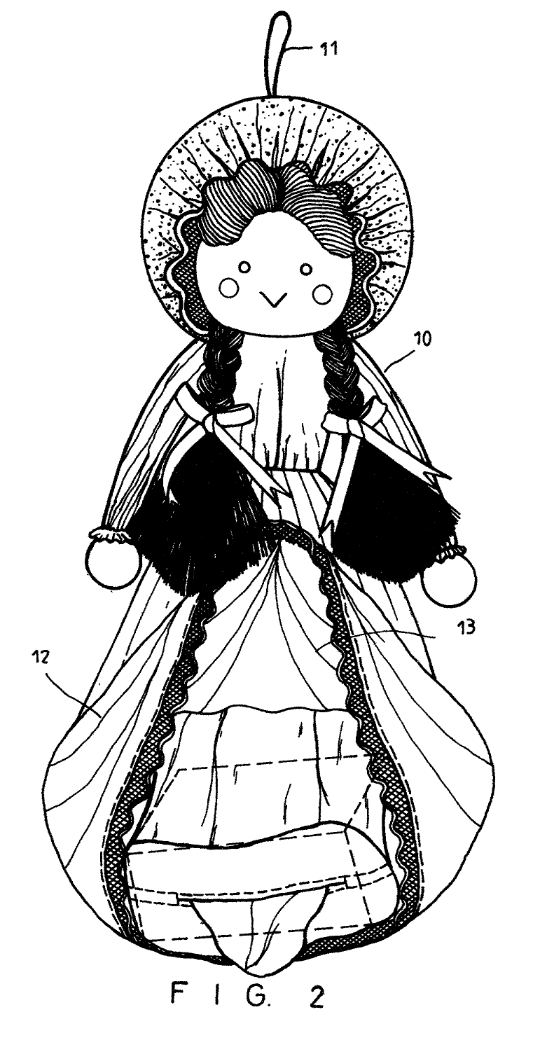

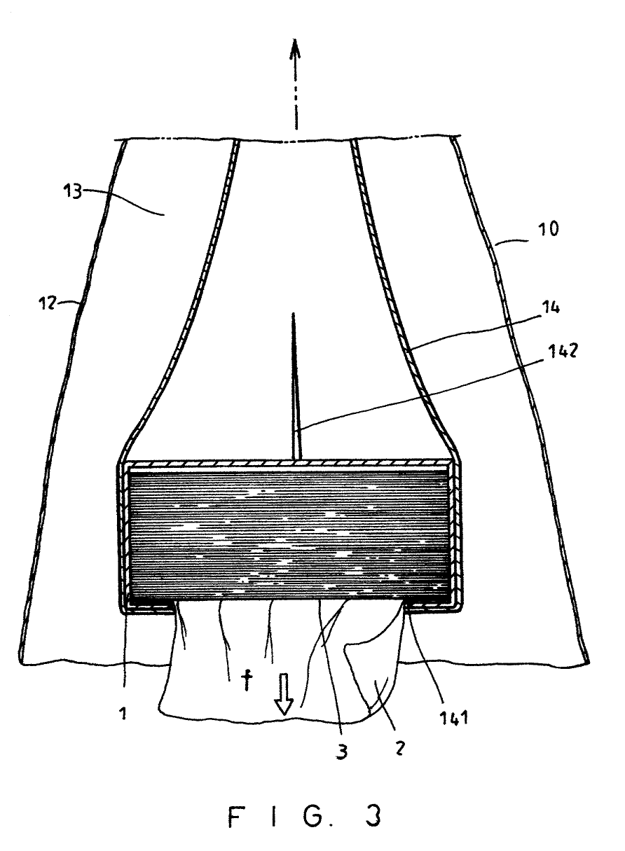

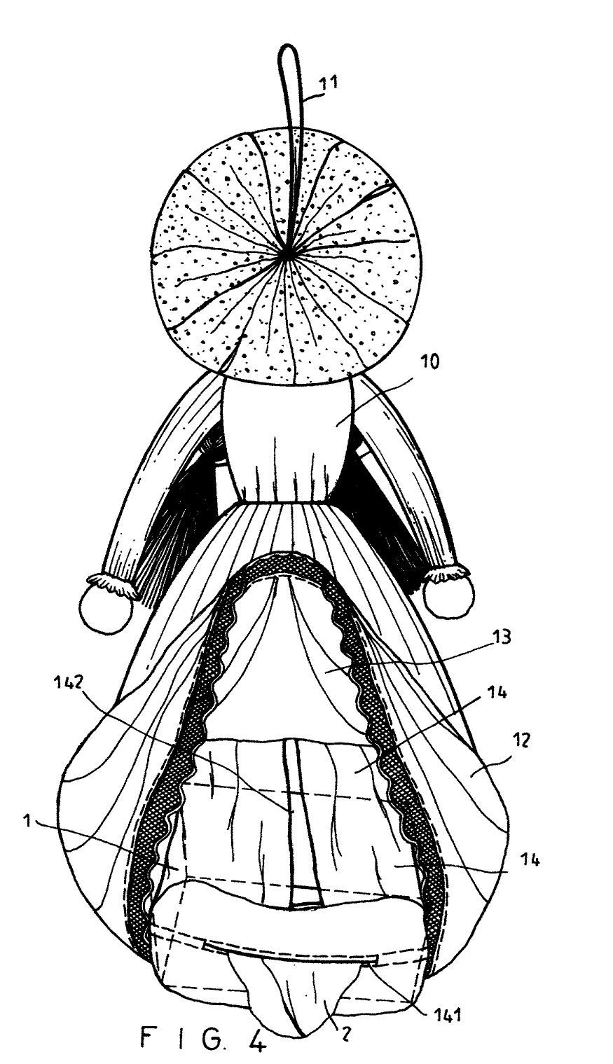

Please refer to FIGS. 2 to 4. An accommodating and positioning device of tissue paper case of the present invention comprises a soft puppet suspending main body 10, and the puppet suspending main body 10 has a string 11 at the top of its head, and a hollow apron body 12 is disposed at the lower section of the soft puppet suspending main body 10 to form an accommodation space for accommodating a tissue paper case 1. In the interior of the accommodation space 13, there is a suspending member 14 for placing the tissue paper case in a plat position, and always keeping the slit for drawing the tissue paper to face downward. Please continue to refer to FIGS. 2 to 4. The suspending member 14 of this embodiment works together with the suspending main body 10 of the entire puppet and it forms a pocket body by sewing to hang and hide the axial interior of the accommodation space 13. The bottom of the suspending member 14 of the pocket body has an opening 141 corresponsive to the slit 3 of the tissue paper case 1, and the abdomen of the puppet (as shown in FIG. 4) has a pocket opening 142 for tying in the tissue paper case.

When such arrangement is used, the user has to lift up the hollow apron body 12 at the lower portion of the puppet suspending main body 10 (as shown in FIG. 4) and exposes the suspending member 14 of the pocket body of its interior, so that a tissue paper case 1 is extended and placed flat into the pocket opening 142 at the rear side of the suspending member 14 of the pocket body, and the first tissue paper in the tissue paper case 1 is drawn from such opening 141. The string 11 is used to hang the puppet suspending main body 10 at the hook on the wall of the room (not shown in the figure) or inside an automobile vehicle. The puppet suspending main body 10 is hung in an appropriate position for easy access for the user.

In the design as shown in FIG. 2, since the tissue paper exposes beyond the opening 141 at the lower section of the suspending member 14 of the pocket body, when the user draws the tissue paper, the force f is exerted downward. The puppet suspending main body is in suspending status, and the tissue paper case 1 is transversally restricted in the interior of the suspending member 14 of the pocket body. The gravitational force will prevent the tissue paper case from being pulled off together with the tissue paper no matter how many pieces of tissue paper 2 left in the tissue paper case. It ensures that each piece of the tissue paper including the last piece of tissue paper left in the case can be definitely drawn.

Furthermore, since the present invention the suspending member 14 for accommodating the tissue paper case 1 is sewed into the puppet suspending main body 10, and the string 11 at the top of the head of the puppet suspending main body 10 is hung vertically on the wall, therefore it will not occupy the space on the tabletop or any horizontal space on the desktop or bookshelves. It can also make use by different forms of puppets for the decoration, and the synergy effect of multiple functions adds more features to the present invention.

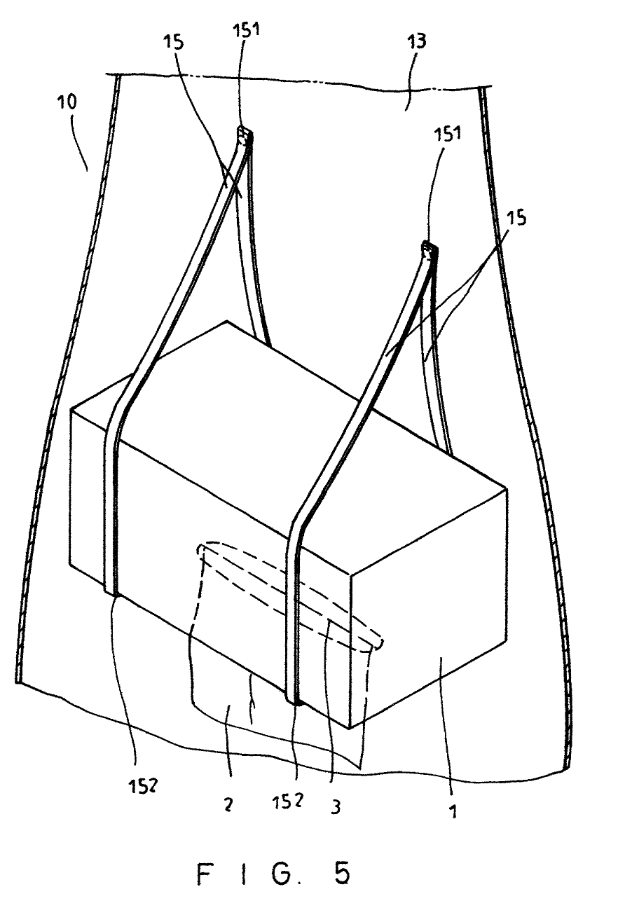

Furthermore, please refer to FIG. 5, another embodiment of the suspending member 14 is disclosed. It comprises a soft puppet suspending main body 10, and unlike the original suspending member 14 in the pocket body design, it changes to use two elastic rings 15 to replace the suspending member 14. As shown in the figure, the two elastic rings are separately disposed on the left and the right, and its upper section is pre-sewed to the top side of the accommodation space 13, and its lower section suspends vertically downwards being tied to both ends of the flat tissue paper case 1 to restrict and keep the slit of the flat tissue paper case to face downward. Such arrangement can attains the purpose of drawing the tissue paper easily from the tissue paper case by using the gravitational force of the tissue paper.

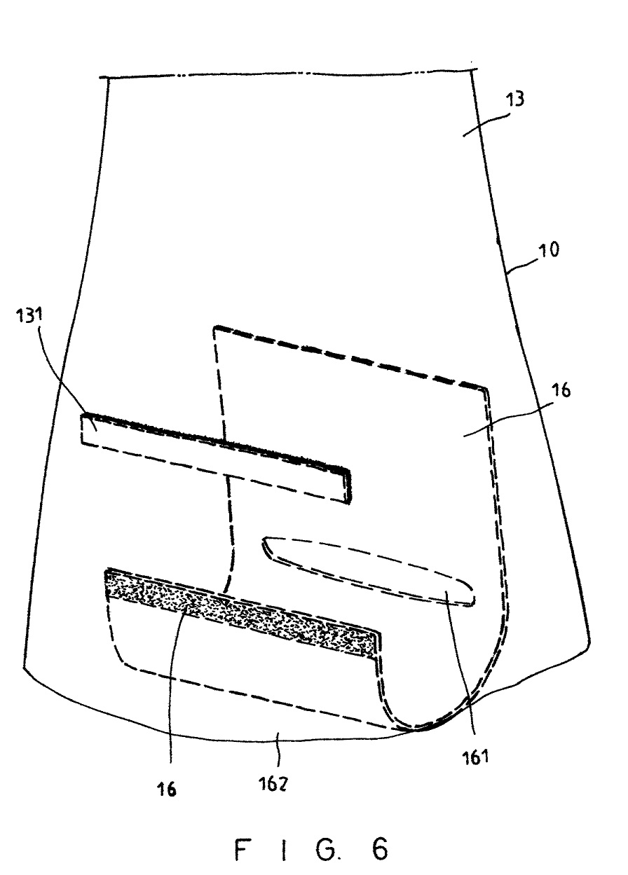

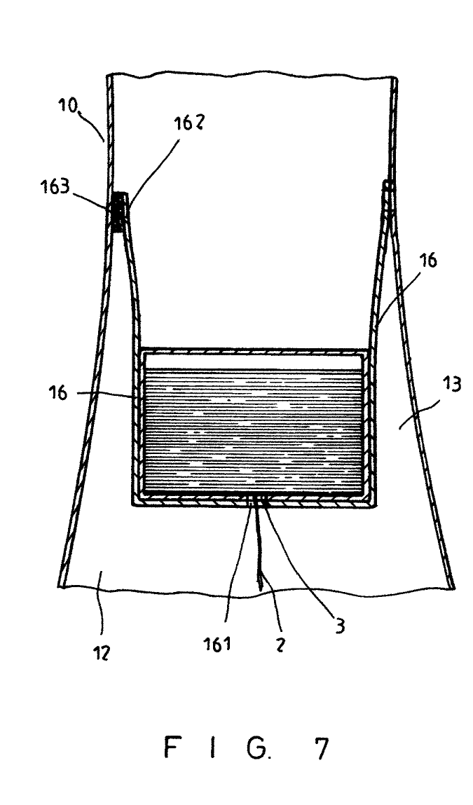

Please refer to FIGS. 6 and 7. The accommodating and positioning device of a tissue paper case incorporates the above-mentioned embodiments, and additionally the design of the suspending member can use another method for the implementation. In FIG. 6, a ribbon body is sewed in the accommodation space 13 of the puppet suspending main body 10, and the middle section of the ribbon body 16 has a transversal opening 161 being disposed at a position corresponding to the slit 2 of the tissue paper case 1. The end 162 of the ribbon body 16 has a set of sticky ribbon 163 (male and female corresponding sticky ribbon), and another set of stick ribbons 131 is disposed on one side of the accommodation space 13 in order to restrict and suspend the flat tissue paper case in the accommodation space in position. It also attains the objective and effect of drawing the tissue paper from the tissue paper case by the gravitational force.

In view of the above description, the present invention overcomes the shortcomings of the prior art and further complies with the patent application requirements and is submitted to the Patent and Trademark Office for review and granting of the commensurate patent rights.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An accommodating and positioning device of tissue paper case, comprising: a suspending main body, its exterior is designed in a predetermined decorative form, for hanging in an automobile vehicle or indoors, and an accommodation space is disposed at the axial bottom side of the suspending main body inside the tissue paper case such that the slit of the tissue paper case for drawing the tissue paper always faces downward, so that the tissue paper can be drawn out of the tissue case very easily due to the gravitational force on the tissue paper, and such structure attains the functions of not occupying too much space, definite drawing of tissue paper, and artistic look.

2. An accommodating and positioning device of tissue paper case as claimed in claim 1, wherein said suspending main body is a puppet having a string attached at the top of its head, and the suspending member is a pocket body made by sewing and hidden in the axial interior of the accommodation space, and an opening corresponsive to the slit from where the tissue paper is drawn is disposed at the bottom of the pocket body, and an pocket opening is disposed at the abdomen of the puppet for tying in the tissue paper case.

3. An accommodating and positioning device of tissue paper case as claimed in claim 1, wherein said suspending main body comprises two separated elastic rings, each of the top sections being pre-sewed to the top of the accommodation space, and each bottom section suspends downward and being tied to both ends of the flat tissue paper case.

4. An accommodating and positioning device of tissue paper case as claimed in claim 1, wherein said suspending main body is a ribbon body being extended down on a lateral side of the accommodation space, and the middle section of said ribbon body is corresponsive to the position of the slit of the tissue paper case and has a transversal opening, and the end of the ribbon body has a set of sticking ribbon for wrapping and sticking to the other side of the accommodation space in order to restrict the suspending position of the plat tissue paper case.
